(19) United States
(12) Patent Application Publication
(10) Pub. No.: US 2024/0376781 A1
(43) Pub. Date: Nov. 14, 2024

(54) GRIPPER, ROCK DRILLING UNIT AND METHOD

(71) Applicant: SANDVIK MINING AND CONSTRUCTION OY, Tampere (FI)

(72) Inventors: Eero MAKKONEN, Tampere (FI); Vesa SILLANPAA, Tampere (FI); Jukka LUUTIKIVI, Tampere (FI)

(21) Appl. No.: 18/656,627

(22) Filed: May 7, 2024

(30) Foreign Application Priority Data
May 9, 2023 (EP) 23172251.3

(51) Int. Cl. E21B 7/02

(52) U.S. Cl. CPC E21B 7/025; E21B 7/022

(57) ABSTRACT

A gripper, a rock drilling unit and a method of handling drilling tools is provided. The gripper includes a hydraulic cylinder and at least one gripping jaw movable by means of the hydraulic cylinder towards and away from the drilling tool. The hydraulic cylinder has at least one adjusting piston having a first operating position with a first fixed stoppage and a second operating position with a fixed second stoppage. The adjusting piston limits movement length of a piston rod at one of the first and second operating positions to provide the gripping jaw with an intermediate position between extreme movement positions of the gripping jaw.

### RELATED APPLICATION DATA

This application claims priority under 35 U.S.C. § 119 to EP patent application Ser. No. 23/172,251.3, filed on May 9, 2023, which the entirety thereof is incorporated herein by reference.

### TECHNICAL FIELD

The invention relates to a gripper for handling rock drilling tools used in rock drilling. The gripper includes at least one gripping jaw movable by means of at least one hydraulic cylinder. The invention further relates to a rock drilling unit provided with a gripper, and to a method of handling rock drilling tools.

### BACKGROUND

In mines, construction sites and at other work areas drill holes are drilled by means of rock drilling units having rock drilling machines arranged movably on feed beams. Drilling tools are connectable to the drilling machines by means of screw joints. The drilling tools may include one or more drill rods or tubes and a drill bit. The feed beams are provided with retainers for holding the drilling tools immovable when coupling and decoupling the drilling tools. Typically, the retainers include gripping jaws which are moved by means of hydraulic cylinders. There are several different retainer designs. However, the present solutions have shown to contain some disadvantages.

### SUMMARY

An object of the invention is to provide a novel and improved gripper and method for handling rock drilling tools. The invention further relates to a drilling unit provided with a retainer and utilizing the disclosed gripper.

An idea of the disclosed solution is that the gripper for handling rock drilling tools includes at least one hydraulic cylinder and at least one gripping jaw movable by means of the hydraulic cylinder towards and away from the drilling tool arranged to pass through the gripper. The hydraulic cylinder has at least one adjusting piston having a first operating position with a first fixed stoppage and a second operating position with a fixed second stoppage. The adjusting piston is configured to limit movement length of the piston rod at one of the first and second operating positions to provide the at least one gripping jaw an intermediate position between extreme movement positions of the at least one gripping jaw.

In other words, the adjusting piston is a pressure operated element by means of which the hydraulic cylinder is provided with three accurate piston rod positions instead of conventional two positions.

The adjusting piston is configured to move between two fixed stoppage surfaces whereby the adjusting piston has two operational positions at its extreme movement directions. Thus, the adjusting piston has no intermediate positions between the extreme fixed positions. At the fixed operational positions, the adjusting piston is forced against physical stoppage surfaces limiting the movement range. Locations of the stoppage surfaces define two operational positions for the adjusting piston and thereby also define two protruding lengths for the piston rod.

An advantage of the disclosed solution is that by means of the adjusting piston the hydraulic cylinder can be controlled in a more versatile manner and the gripper can be utilized better. Further, the fixed positions define accurate piston rod protrusion lengths. The movements of the piston are simple to control.

The gripper is also applicable for handling of drilling tools with different dimensions, and it can be retrofitted to existing drilling units.

According to an embodiment, the gripper is provided with three operational modes, wherein each mode has a different protruding length for the piston rod and wherein magnitude of the protruding length of the piston rod is configured to define position of the at least one gripping jaw in relation to the rock drilling tool being handled. In other words, the piston has fully retracted or shortened position, and two different extended or lengthened positions which define the operational modes.

According to an embodiment, the gripper has an open mode, a guiding mode, and a gripping mode. The piston rod moves to an extreme first protruding length in response to selection of the open mode and moves to an opposite extreme second protruding length in response selection of the gripping mode. Further, the piston rod is moved to an intermediate position between the extreme first and second protruding lengths in response to selection of the guiding mode. In other words, the open mode is utilized to provide the gripper with no grip and no contact whatsoever to the rock drilling tool. In the guiding mode there is a kind of soft grip wherein the at least one gripping jaw is close to the outer surface of the drilling tool, but does not press against it. In a gripping mode strong grip against the rock drilling tool is provided. Movement of the drilling tool in the gripping mode is prevented with the strong grip.

According to an embodiment, the structure and mechanics of the gripper can be designed in several alternative ways, whereby the maximum protruding length of the piston rod may be implemented either for producing the open mode or the gripping mode. The same applies also for the minimum protruding length of the piston rod which can be utilized for either producing the open mode or the gripping mode depending on the structure of the gripper.

According to an embodiment, at least the guiding mode is defined by the adjusting piston.

According to an embodiment, the piston rod has minimum protruding length in response to selection of the open mode; and the piston rod has maximum protruding length in response to selection of the gripping mode.

According to an embodiment, the gripper has an idle mode wherein all pressure spaces of the hydraulic cylinder are connected to at least one tank pressure line. In other words, the piston rod is free to move in either of its movement directions under influence of external forces. The cylinder is then pressure free.

According to an embodiment, the adjusting piston is a sleeve-like piece mounted movably on the piston rod. In other words, the adjusting piston is a kind of a floating piston which can slide on the piston rod and move towards to its two extreme control positions. An advantage of this solution is that movements of the adjusting piston are well controlled when being supported on the piston rod. The structure of the adjusting piston can be simple and robust.

According to an embodiment, the adjusting piston has a first face surface facing towards the piston and being provided with a ring shaped axial protrusion facing towards the piston and diameter of which is minor than outer diameter of the adjusting piston whereby the axial protrusion is configured to serve as an axial stoppage surface for the piston when the adjusting piston is moved to its extreme position towards the piston.

According to an embodiment, alternatively or in addition to, the first axial protrusion of the adjusting piston, the piston is provided with a second axial protrusion facing towards the adjusting piston.

According to an embodiment, the hydraulic cylinder includes three working pressure spaces wherein prevailing pressure is adjustable for moving the piston and for moving a relative position of piston and the adjusting piston. In other words, the hydraulic cylinder includes a first working pressure space on the piston side, a second working pressure space and a third working pressure space both being on the rod side. The second working pressure space is located between the piston and the adjusting piston, whereas the third working pressure space is located on an opposite side of the adjusting piston compared to the second working pressure space. The working pressure spaces are connectable to pressure lines and discharge lines by controlling control valves.

According to an embodiment, the gripper is a part of a retainer having two hydraulic cylinders mounted on opposite sides in relation to the drilling tool arranged to pass through the retainer. Piston rods of the hydraulic cylinders are facing towards each other, and the retainer includes two gripping jaws which are mounted to distal ends of the piston rods.

According to an embodiment, the two hydraulic cylinders are controlled in a simultaneous and synchronous manner so that their piston rods move in similar manner.

According to an embodiment, the two hydraulic cylinders are controlled independently in relation to each other. Then a first hydraulic cylinder may be controlled to move a first gripping jaw close to the drilling tool being handled i.e., to move to a base position, and a second hydraulic cylinder may be controlled to move a second gripping jaw to the positions being in accordance with principles of the open mode, guiding mode and gripping mode.

According to an embodiment, the gripper is part of a retainer including an articulated lever mechanism configured to transmit the movements of the hydraulic cylinder to the gripping jaws mounted to lever arms of the lever mechanism. In other words, one hydraulic cylinder can move the lever mechanism and provide the disclosed movements and modes for the gripping jaws.

According to an embodiment, the gripper is part of a rod handler for moving the rock drilling tools on a drilling axis and including one movable gripping jaw movable in relation to a fixed counterpart.

According to an embodiment, the disclosed solution relates also to a rock drilling unit for drilling holes to rock surfaces. The rock drilling unit includes: a feed beam: a rock drilling machine mounted movably on the feed beam; and a retainer at a front end portion of the feed beam and being capable to selectively grip to a drilling tool mountable to the rock drilling machine. Further, the retainer is provided with a gripper which is in accordance with the features and embodiments disclosed in this document.

According to an embodiment, the disclosed solution relates also to a rock drilling unit for drilling holes to rock surfaces. The rock drilling unit includes: a feed beam: a rock drilling machine mounted movably on the feed beam; and a rod handler for moving drilling tools between a tool magazine and drilling axis; and wherein the rod handler is provided with a gripper being capable to selectively grip to the drilling tools mountable to the rock drilling machine. Further, the gripper of the rod handler is in accordance with the features and embodiments disclosed in this document.

According to an embodiment, the disclosed solution relates also to a method of handling a drilling tool on a rock drilling unit. The method includes: drilling a drill hole to the rock surface by means of the rock drilling unit: gripping the drilling tool by means of at least one gripping jaw of a gripper mounted on the drilling unit; and moving the at least one gripping jaw in relation to the drilling tool by means of at least one hydraulic cylinder of the gripper. The method further includes using the gripper as disclosed in this document and providing the gripper with at least three operational modes with different relative positions of the at least one gripping jaw.

The above disclosed embodiments may be combined in order to form suitable solutions having those of the above features that are needed.

The foregoing summary, as well as the following detailed description of the embodiments, will be better understood when read in conjunction with the appended drawings. It should be understood that the embodiments depicted are not limited to the precise arrangements and instrumentalities shown.

### BRIEF DESCRIPTION OF THE FIGURES

FIG. 1 is a schematic side view of a rock drilling rig provided with a drilling unit.

FIG. 2 is a schematic top view of a drilling unit provided with a retainer.

FIG. 3 is a schematic view showing three operational modes of a gripper.

FIG. 4 is a schematic top view showing a retainer provided with a gripper with one hydraulic cylinder opposing a fixed gripping jaw.

FIGS. 5 and 6 are schematic views showing some mechanics for transmitting forces from a hydraulic cylinder to gripping jaws.

FIG. 7 is a schematic view of a part of gripper which is provided with one fixed gripping jaw and one movable gripping jaw.

FIG. 8 is a schematic view illustrating operational modes of a hydraulic cylinder provided with an adjusting cylinder.

FIG. 9 is a schematic view of a hydraulic cylinder and a hydraulic circuit of a gripper in an open mode.

FIG. 10 is a schematic view of a hydraulic cylinder and a hydraulic circuit of a gripper in a guide mode.

FIG. 11 is a schematic view of a hydraulic cylinder and a hydraulic circuit of a gripper in a free mode.

FIG. 12 is a schematic view of a hydraulic cylinder and a hydraulic circuit of a gripper in a gripping mode.

FIG. 13 is a schematic view of a rod handler seen in a direction of a feed beam.

FIG. 14 is a schematic detailed view of a gripper of a rod handler.

For the sake of clarity, the figures show some embodiments of the disclosed solution in a simplified manner. In the figures, like reference numerals identify like elements.

### DETAILED DESCRIPTION

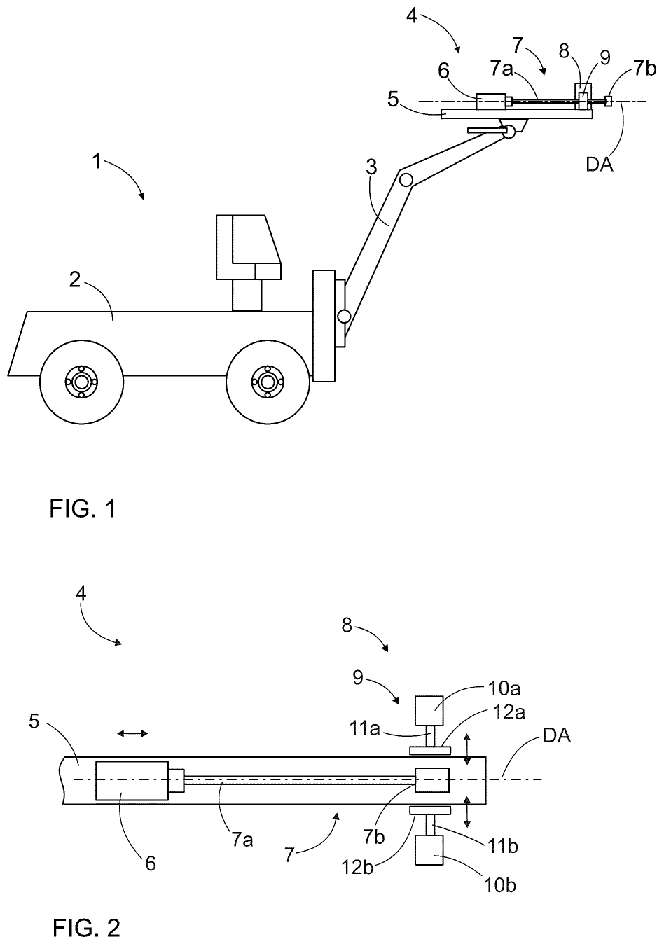

FIG. 1 discloses a rock drilling rig 1 including a carrier 2, at least one drilling boom 3 and a drilling unit 4 located at a distal end portion of the boom 3. The drilling unit 4 includes a feed beam 5 and a rock drilling machine 6 supported on the feed beam 5 and arranged to be move longitudinally to drilling axis DA by means of a feed device.

Drilling tools 7, such as drill rods 7a and drill bits 7b may be fastened to the drilling machine 6 for directing impact pulses and rotation to rock surface being drilled. At a front end portion of the feed beam may be a retainer 8 for fixedly supporting the drilling tools 7 on the drilling axis DA when the drilling tools 7 are mounted and dismounted. The retainer 8 includes a gripper 9 as described herein.

FIG. 2 discloses a retainer 8 at one end portion of a feed beam 5. A rock drilling machine 6 can be moved on the feed beam 5 and drilling tools 7 connected to the drilling machine 6 to drilling axis DA and pass through a gripper 9 being part of the retainer 8. The gripper 9 includes two hydraulic cylinders 10a, 10b mounted on opposite sides in relation to the drilling tool 7. Piston rods 11a, 11b of the hydraulic cylinders 10a, 10b are facing towards each other and are provided with two gripping jaws 12a. 12b. The hydraulic cylinders 10a. 10b include the features and functionality disclosed herein.

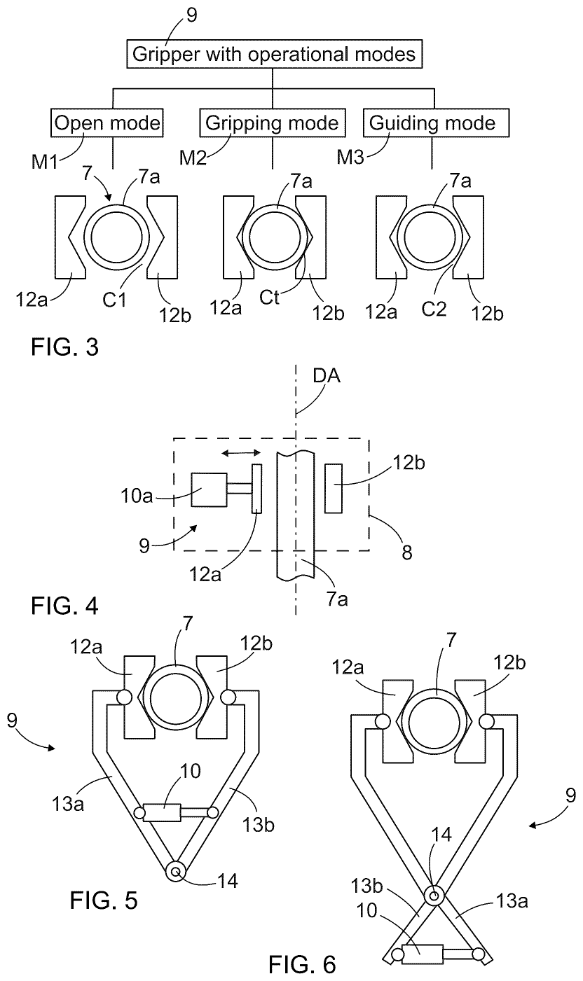

FIG. 3 discloses that a gripper 9 may be provided with at least three modes. The modes may be an open mode M1, a gripping mode M2 and a guiding mode M3. Drilling tool 7 passing the through gripping jaws 12, 12b is a drilling rod 7a in FIG. 3. In the open mode M1, the gripper 9 is controlled so that no grip and no contact occurs between gripping jaws 12a. 12b and the drilling rod 7a. In the guiding mode M3, there is a kind of soft grip, wherein the gripping jaws 12a, 12b are close to the outer surface of the drilling tool but do not press against it. In other words, in the open mode M1 a clearance C1 is greater than a clearance C2 in the guiding mode M3. In the gripping mode M2 there is strong grip against the drilling rod 7a. Movement of the drilling tool 7 in the gripping mode M2 is prevented with the strong grip. In the gripping mode M2 there is of course contact Ct and no clearance between the gripping jaws 12a, 12b and the drilling rod 7a.

FIG. 4 discloses a retainer 8 provided with a gripper 9 with one hydraulic cylinder 10a for moving one movable gripping jaw 12a. The gripping jaw 12a is movable in relation to an immovably arranged gripping jaw 12b in a manner disclosed herein for providing the operational modes.

FIGS. 5 and 6 disclose possible mechanisms for grippers 9 for moving the two gripping jaws 12, 12b towards and away from drilling tool 7. In these solutions, one dedicated hydraulic cylinder 10 is sufficient to produce required movements for the gripping jaws 12a, 12b, since the hydraulic cylinders 10 are arranged between mechanical arms 13a, 13b connected to each other turnable around joints 14.

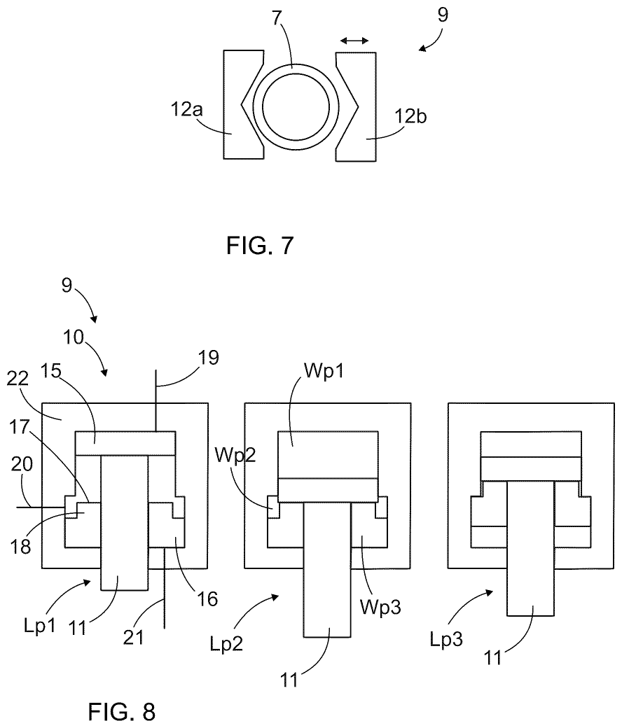

FIG. 7 further shows that the gripper 9 may include one fixed gripping jaw 12a and one movable gripping jaw 12b. Movement of the gripping jaw 12b is generated either directly or indirectly by means of a hydraulic cylinder as disclosed herein. The gripper 9 with one movable gripping jaw can be utilized in a versatile manner for handling different tools and pieces used in the drilling process.

FIG. 8 discloses an example structure of hydraulic cylinder 10 of gripper 9. The gripper 9 is provided with three different protruding length positions Lp1 for piston rod 11 movable by means of a piston 15. A magnitude of the protruding length of the piston rod 11 defines a position of a gripping jaw, which is not shown.

The piston rod 11 may have a fully retracted position (left, Lp1), a partly extended intermediate position (right, Lp3) and a fully extended position (middle, Lp2), which positions define operational modes M1-M3 of the gripper 9.

There is an adjusting piston 16 for effecting to the movements of the piston 15 and the piston rod 11. At least the intermediate length position Lp3 on the right side is defined by means of the adjusting piston 16. The adjusting piston 16 is a sleeve-like piece mounted movably on the piston rod 11. The adjusting piston 16 may be a kind of a floating piston which can slide on the piston rod 11 and move towards to its two extreme control positions. The adjusting piston 16 has a first face surface 17 facing towards the piston 15 and being provided with a ring shaped axial protrusion 18 facing towards the piston 15. The diameter of axial protrusion 18 is smaller than the outer diameter of the adjusting piston 16, whereby the axial protrusion 18 is able to serve as an axial stoppage surface for the piston 15 when the adjusting piston 16 is moved to its extreme position towards the piston 15. Further, the hydraulic cylinder 10 includes three working pressure spaces Wp1, Wp2 and Wp3, wherein prevailing pressure is adjustable for moving the piston 15 and for moving the relative position of the piston 15 and the adjusting piston 16. The first working pressure space Wp1 is on the piston side, the second working pressure space Wp2 is located between the piston 15 and the adjusting piston 16, and the third working pressure space Wp3 is located on an opposite side of the adjusting piston compared to the second working pressure space Wp2. The working pressure spaces Wp1-Wp3 are connected to one or more pressure fluid lines 19, 20 and 21.

As can be noted in FIG. 8, when the piston 11 is in the length position Lp1 it is moved to its upmost extreme position, and in the length position Lp2 the piston 15 is moved to its lowermost extreme position against the adjusting piston 16, which is also at its lowermost extreme position. In the length position Lp3, the adjusting piston 16 is moved to its upmost extreme position and the piston 15 is set against the axial protrusion 18 so that the intermediate position is achieved. FIG. 8 clearly discloses that the adjusting piston 16 moves between its extreme axial positions against fixed surfaces of a body 22 without any intermediate positions.

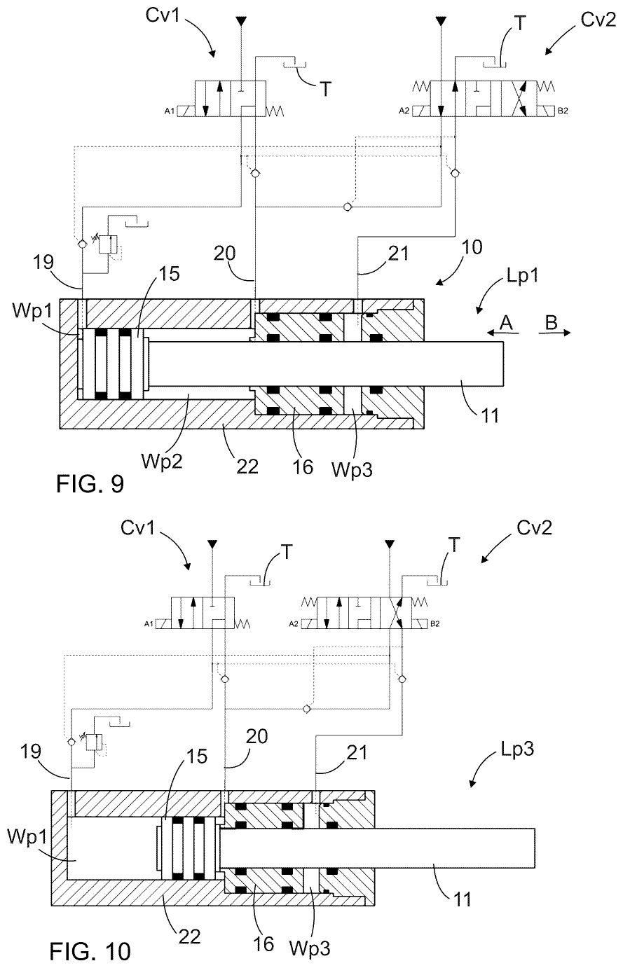

FIGS. 9-12 disclose a structure of hydraulic piston 10 and a hydraulic circuit for operating it and providing different length positions Lp1-Lp3 for piston rod 11. The hydraulic circuit may include two control valves, a first control valve Cv1 and a second control valve Cv2 by means of which pressure fluid is fed and discharged to and from working pressure spaces Wp1-Wp3, for moving piston 15 and adjusting piston 16 to the desired positions. The control valves Cv1 and Cv2 are connected to pressure fluid lines 19, 20 and 21.

In FIG. 9, the first control valve Cv1 connects first working pressure space Wp1 to a tank T, whereby the piston 15 can move to its left most position since the second control valve Cv2 directs pressure fluid to the second working pressure space Wp2. Fluid flow from the third working pressure space Wp3 to tank T is prevented. When the piston rod 11 is retracted it has its shortest possible position. In FIG. 9, a first movement direction is marked as A and an opposite second movement direction is marked as B.

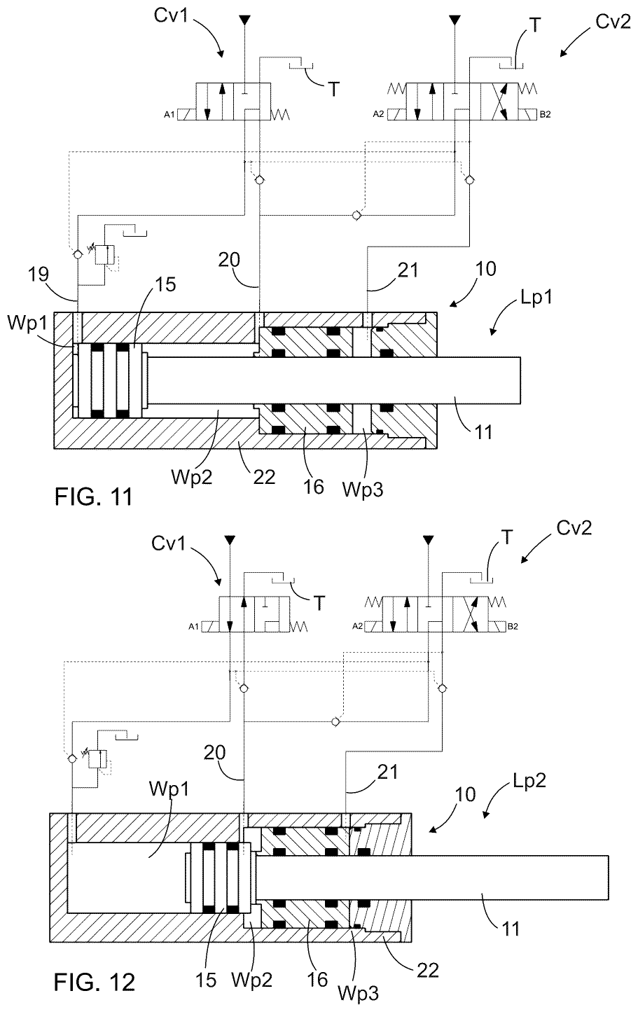

In FIG. 10, the piston rod 11 is in its intermediate position, wherein the adjusting piston 16 limits movement of the piston 15 to the right. The second control valve Cv2 has changed its position and directs pressure fluid flow to the third working pressure space Wp3 and connects the second working pressure space Wp2 to the tank T.

In FIG. 11, the piston rod 11 is in the same length position Lp1 as in FIG. 9, but is free to move in either of its movement directions since the second control valve Cv2 is moved to its central position. All the working pressure spaces Wp1-Wp3 are connected to the tank T by means of the control valves Cv1 and Cv2.

In FIG. 12, the piston rod 11 is fully ejected and has its longest possible position. The adjusting piston 16 has moved to its right most position since the third working pressure space Wp3 is connected to the tank T by means of the second control valve Cv2. The second working pressure space Wp2 is connected to the tank T by means of the first control valve Cv1. The first control valve Cv1 has changed its position and directs pressure fluid flow to the first working pressure space Wp1 whereby the piston 15 is moved towards its right most extreme position. In FIGS. 9-12 control pressure lines are shown in broken lines.

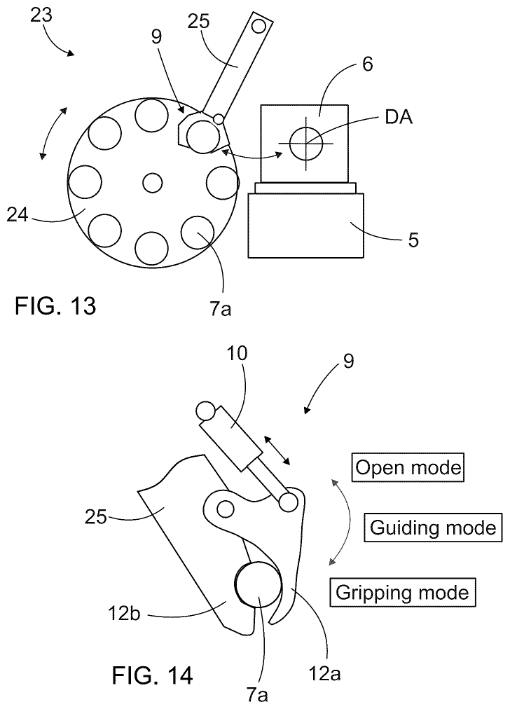

FIG. 13 discloses gripper 9 arranged in connection with a rod handling apparatus 23. The apparatus 23 may include a magazine 24 for storing several drill rods 7a. The magazine 24 may be rotatably mounted or may include other means for indexing. There is also a movable arm or manipulator 25 provided with the gripper 9. The manipulator 25 can move the drill rods 7a between the magazine 24 and drilling axis DA of a rock drilling apparatus 6.

The gripper 9 is disclosed in more detail in FIG. 14, wherein it is shown that the gripper 9 may include one movable gripping jaw 12a and one immovable gripping jaw 12b, which may be a structural part of the manipulator 25 or may be a separate part mounted on the manipulator 25. Hydraulic cylinder 10 for moving the movable gripping jaw 12a is in accordance with the features and embodiments disclosed herein and may be configured to provide the gripper 9 with the gripping mode, guiding mode and the open mode.

It may also be possible to use the same kind of apparatus 23 for handling other drilling tools, such as drill bits.

Although the present embodiment(s) has been described in relation to particular aspects thereof, many other variations and modifications and other uses will become apparent to those skilled in the art. It is preferred therefore, that the present embodiment(s) be limited not by the specific disclosure herein, but only by the appended claims.

What is claimed is:

1. A gripper arranged for handling rock drilling tools, wherein the gripper comprising:
at least one hydraulic cylinder including a body, a piston, a piston rod connected to the piston, working pressure spaces, and a plurality of pressure fluid channels connected to the working pressure spaces for feeding and discharging pressurized hydraulic fluid for moving the piston in a first movement direction and in an opposite, second movement direction; and
at least one gripping jaw movable by the hydraulic cylinder towards and away from the drilling tool, which is arranged to pass through the gripper, wherein the at least one hydraulic cylinder includes at least one adjusting piston having a first operating position with a first fixed stoppage and a second operating position with a fixed second stoppage, and wherein the adjusting piston is configured to limit movement length of the piston rod at one of the first and second operating positions to situate the at least one gripping jaw in an intermediate position between extreme movement positions of the at least one gripping jaw.

2. The gripper as claimed in claim 1, wherein the gripper is provided with three operational modes, wherein each mode has a different protruding length of the piston rod and wherein a magnitude of the protruding length of the piston rod is configured to define a position of the at least one gripping jaw in relation to the rock drilling tool being handled.

3. The gripper as claimed in claim 2, wherein the operational modes of the gripper are an open mode, a guiding mode, and a gripping mode, the piston rod being configured to be moved to an extreme first protruding length in response to selection of the open mode, and to an opposite extreme second protruding length in response selection of the gripping mode, and wherein the piston rod is configured to be moved to an intermediate position between the extreme first and second protruding lengths in response to selection of the guiding mode.

4. The gripper as claimed in claim 1, wherein the gripper has an idle mode whereby the pressure spaces of the hydraulic cylinder are connected to at least one tank pressure line.

5. The gripper as claimed in claim 1, wherein the at least one adjusting piston is a sleeve-like piece mounted movably on the piston rod.

6. The gripper as claimed in claim 1, wherein the adjusting piston has a first face surface facing towards the piston and being provided with a ring shaped axial protrusion facing towards the piston, a diameter of the axial protrusion being smaller than an outer diameter of the adjusting piston, and wherein the axial protrusion is configured to serve as an axial stoppage surface for the piston when the adjusting piston is moved to its extreme position towards the piston.

7. The gripper as claimed in claim 1, wherein there are three working pressure spaces in the at least one hydraulic cylinder, and wherein a prevailing pressure is adjustable for moving the piston and for moving a relative position of the piston and the adjusting piston.

8. The gripper as claimed in claim 1, wherein the gripper is part of a retainer including two hydraulic cylinders mounted on opposite sides in relation to the drilling tool arranged to pass through the retainer, and wherein the piston rod of each of the two hydraulic cylinders face towards each other, the retainer including two gripping jaws, which are mounted to distal ends of both piston rods.

9. The gripper as claimed in claim 1, wherein the gripper is part of a retainer including an articulated lever mechanism configured to transmit movements of the at least one hydraulic cylinder to the gripping jaws mounted to lever arms of the lever mechanism.

10. The gripper as claimed in claim 1, wherein the gripper is part of a rod handler arranged for moving the rock drilling tools to a drilling axis of a rock drilling machine, the gripper including one movable gripping jaw movable in relation to a fixed counterpart jaw.

11. A rock drilling unit arranged for drilling holes in rock surfaces, the rock drilling unit comprising:
a feed beam;
a rock drilling machine mounted movably on the feed beam; and
a retainer disposed at a front end portion of the feed beam, the retainer being arranged to selectively grip a drilling tool mountable to the rock drilling machine, wherein the retainer includes a gripper as claimed in claim 1.

12. A rock drilling unit arranged for drilling holes in rock surfaces, the rock drilling unit comprising:
a feed beam;
a rock drilling machine mounted movably on the feed beam; and
a rod handler arranged for moving drilling tools between a tool magazine and a drilling axis of the rock drilling machine, wherein the rod handler is provided with a gripper as claimed in claim 1 and arranged to selectively grip to the drilling tools mountable to the rock drilling machine.

13. A method of handling a drilling tool on a rock drilling unit, the method comprising:
drilling a drill hole in a rock surface by means of the rock drilling unit;
gripping the drilling tool by at least one gripping jaw of a gripper as claimed in claim 1, the gripper being mounted on the drilling unit; and
moving the at least one gripping jaw in relation to the drilling tool by means of at least one hydraulic cylinder of the gripper; and
using the gripper in at least three operational modes, each mode having a different relative position of the at least one gripping jaw.
